(19) United States
(12) Patent Application Publication
(10) Pub. No.: US 2003/0107611 A1
(43) Pub. Date: Jun. 12, 2003

(54) Ink jet printer and method of reducing maximum driving current of ink cartridge

(75) Inventor: Jung-hwan Kim, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/173,921

(22) Filed: Jun. 19, 2002

(30) Foreign Application Priority Data
Dec. 7, 2001 (KR) 2001-77418

(51) Int. Cl. B41J 29/38

(52) U.S. Cl. 347/12

(57) ABSTRACT

An ink jet printer reducing maximum current consumed by an ink jet print head includes a controller outputting addresses for selecting nozzles, a first enable signal, and a second enable signal, and an ink cartridge deriving a first group of nozzles in response to the addresses and the first enable signal, and for driving a second group of the nozzles in response to the addresses and the second enable signal, wherein the first and second enable signals are generated by a predetermined time difference. The first group and the second group of the nozzles are not driven at the same time and are aligned at different positions.

### CROSS-REFERENCE TO RELATED APPLICATIONS

This Application claims the benefit of Korean Application No. 2001-77418, filed Dec. 7, 2001, in the Korean Industrial Property Office, the disclosure of which is incorporated herein by reference.

### BACKGROUND OF THE INVENTION

1. Field of the Invention

The present invention relates to an ink jet printer, and more particularly, to an ink jet printer and method of reducing a maximum current consumed by an ink jet print head of the ink jet printer.

2. Description of the Related Art

In general, an ink jet printer emits ink contained in an ink cartridge onto paper to print characteristics or images, using an ink jet print head of the ink cartridge. The ink cartridge includes components, such as the ink jet print head and a cartridge body, for generating ink dot patterns. A plurality of nozzles are aligned in the ink jet print head to emit the ink onto the paper.

FIG. 1 is a block diagram of a conventional printer 100 that is capable of reducing a maximum driving current of an ink cartridge 30 of the conventional ink jet printer 100, and FIGS. 2A-2E show timing diagrams. Referring to FIG. 1, the ink jet printer 100 includes a controller 10 and the ink cartridge 30 that is installed in a carriage of the ink jet printer 100.

The controller 10 outputs a nozzle group selection address ADATA, a nozzle selection address PDATA, an enable signal Fire_EN, a clock signal DCLK, and a data latch enable signal Load to the ink cartridge 30 as shown in FIGS. 1 and 2A-2E. The nozzle group selection address ADATA is an address for selecting nozzle groups that are heated to eject the ink at the same time. Here, each nozzle group includes a plurality of nozzles. The nozzle selection address PDATA is an address for selecting each nozzle, and the enable signal Fire_EN is a control signal for controlling the heating of the nozzles and the ejecting of the ink.

Referring to FIG. 1, nozzles are selected to be heated and to eject the ink in response to the nozzle group selection address ADATA and the nozzle selection address PDATA. Thereafter, the enable signal Fire_EN is activated to operate the plurality of nozzles at a time.

In the past, odd numbered nozzles and even numbered nozzles were selected by the nozzle group selection address ADATA at the same time, and therefore, the maximum number of nozzles that are driven at a time was the sum of the odd numbered nozzles and the even numbered nozzles.

For instance, if current required by each nozzle is 200 mA, and if there are ten even numbered and ten odd numbered nozzles, a maximum of twenty nozzles are driven in response to the nozzle group selection address ADATA, the nozzle selection address PDATA and the enable signal Fire_EN. At this time, a maximum current of 4 A flows momentarily through the ink jet print head. In this case, a maximum power of 40 W is consumed by the ink jet print head, assuming that the voltage required to operate each ink jet print head is 10 V.

Since a large maximum current is consumed by the ink jet print head, and thus, a high-output maximum power supply is required, the manufacturing cost of the ink jet printer increases. Also, since the large maximum current flows through the ink jet printer, noise is generated to cause distortion of signals.

### SUMMARY OF THE INVENTION

To solve the above problems, it is an object of the present invention to provide a printer capable of reducing a maximum current consumed by an ink jet print head, and a method thereof.

Additional objects and advantageous of the invention will be set forth in part in the description which follows and, in part, will be obvious from the description, or may be learned by practice of the invention.

To achieve the above and other objects, there is provided an ink jet printer including a controller outputting addresses selecting respective nozzles, a first enable signal, and a second enable signal, and an ink cartridge driving a first group of the nozzles in response to the addresses and the first enable signal, and driving a second group of the nozzles in response to the addresses and the second enable signal, wherein the first and second enable signals are generated by a predetermined time difference.

The first group and the second group of the nozzles are not driven at the same time, and are aligned at different positions.

To achieve the above and other objects, there is provided a method of operating an ink jet cartridge, the method including generating addresses selecting respective nozzles, a first enable signal, and a second enable signal, driving a first group of the nozzles in response to the addresses and the first enable signal, and driving a second group of the nozzles in response to the addresses and the second enable signal, wherein the first and second enable signals are generated by a predetermined time difference.

To achieve the above and other objects, there is provided a method of operating an ink jet cartridge, the method including outputting first and second enable signals to the ink jet cartridge, driving a first group of ink-jet nozzles in response to the first enable signal, and driving a second group of ink-jet nozzles in response to the second enable signal, wherein the first and second enable signals are generated by a predetermined time difference.

The first group and the second group of the ink-jet nozzles are aligned at different positions.

### BRIEF DESCRIPTION OF THE DRAWINGS

These and other objects and advantages of the present invention will become more apparent and more readily appreciated from the following description of the preferred embodiments, taken in conjunction with the accompanying drawings in which:

FIG. 1 is a block diagram of a conventional printer generating a maximum driving current;

FIGS. 2A-2E show timing diagrams of the conventional printer of FIG. 1;

FIG. 3 is a block diagram of a printer according an embodiment of the present invention, capable of reducing the maximum driving current;

FIGS. 4A-4F are timing diagrams of the printer of FIG. 3; and

FIG. 5 illustrates an embodiment of an ink jet print head and ink jet nozzles of the printer of FIG. 3.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

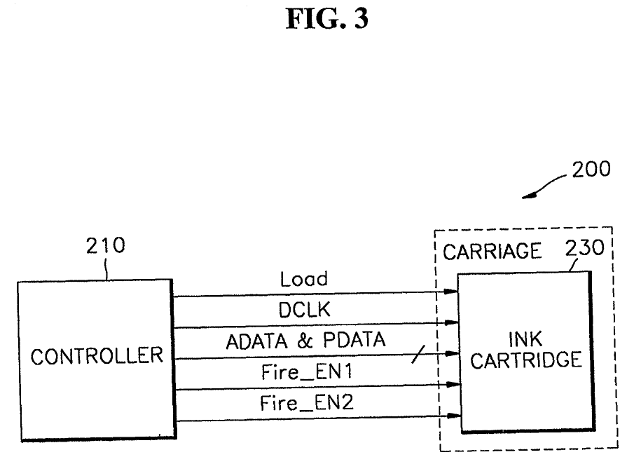

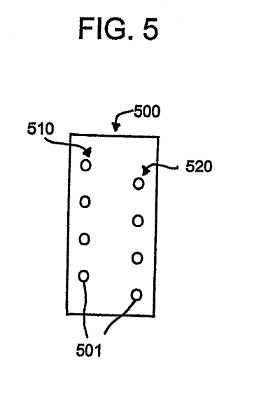

FIG. 3 is a block diagram of an ink jet printer 200, according to an embodiment of the present invention, capable of reducing a maximum driving current of an ink cartridge 230 of the ink jet printer 200. Referring to FIGS. 3 and 5, the ink jet printer 200 includes a controller 210 and the ink cartridge 230 that is installed in a carriage. The ink cartridge 230 includes one or more ink jet print heads 500 and a nozzle driving circuit connected to the ink cartridge 230 and the ink jet print heads. Ink jet nozzles 501 that eject ink onto paper are aligned in the one or more ink jet print heads 500 and the ink jet nozzles 501 are driven by the nozzle driving circuit.

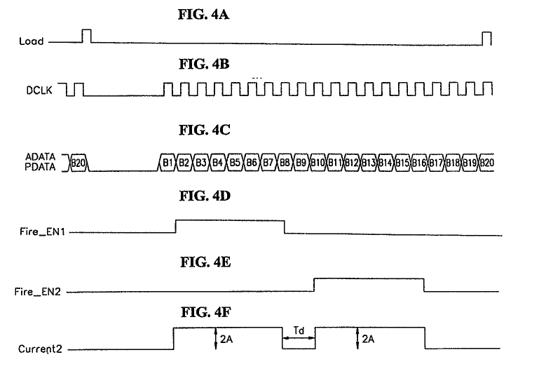

The controller 210 outputs a nozzle group selection address ADATA, a nozzle selection address PDATA, a first enable signal Fire_EN1, a second enable signal Fire_EN2, a clock signal DCLK, and a data latch enable signal Load to the ink cartridge 230 as shown in FIGS. 3 and 4A-4F. The nozzle group selection address ADATA is an address for selecting a nozzle group, which is to be driven, out of a plurality of nozzles groups 510, 520. Each of the nozzle groups 510, 520, such as odd numbered nozzles and even numbered nozzles, includes a plurality of nozzles 501.

The nozzle selection address PDATA is an address for selecting the nozzle 501 to be driven. The first and second enable signals Fire_EN1 and Fire_EN2 are control signals for controlling a first nozzle driving circuit that drives odd numbered nozzles 510 and a second nozzle driving circuit that drives even numbered nozzles 520, respectively. When respective nozzles 501 are selected by the nozzle group selection address ADATA and the nozzle selection address PDATA, the selected nozzles 501 are driven in response to the first and second enable signals Fire_EN1 and Fire_EN2.

The controller 210 outputs the first and the second enable signals Fire_EN1 and Fire_EN2 to the ink cartridge 230. The first and the second enable signals Fire_EN1 and Fire_EN2 are generated by a predetermined time difference Td. The predetermined time difference Td can be controlled by the controller 210.

If the odd numbered nozzles are selected by the nozzle group selection address ADATA and the nozzle selection address PDATA, the selected nozzles 501 are driven in response to the first enable signal Fire_EN1. Also, if the even numbered nozzles 520 are selected in response to the nozzle group selection address ADATA and the nozzle selection address PDATA, the selected nozzles 501 are driven by the second enable signal Fire_EN2.

Therefore, due to the controller 210, the maximum number of nozzles 501 which are driven at the same time can be reduced to half of the maximum number of the nozzles of the conventional ink jet printers. Therefore, the maximum current consumed by the ink jet print heads 500 is reduced to half of the maximum current consumed by the conventional ink jet printers. Also, it is advantageous to control the half of the maximum number of the nozzles 501 to be driven by the controller 210.

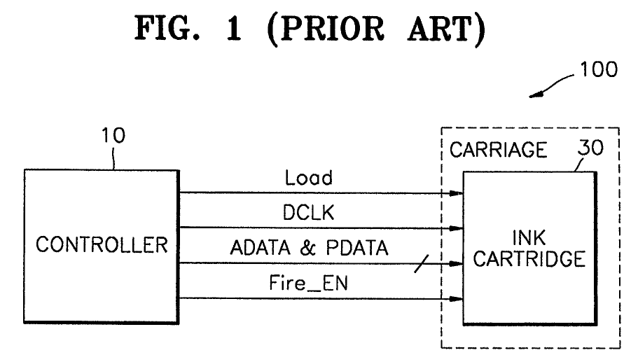

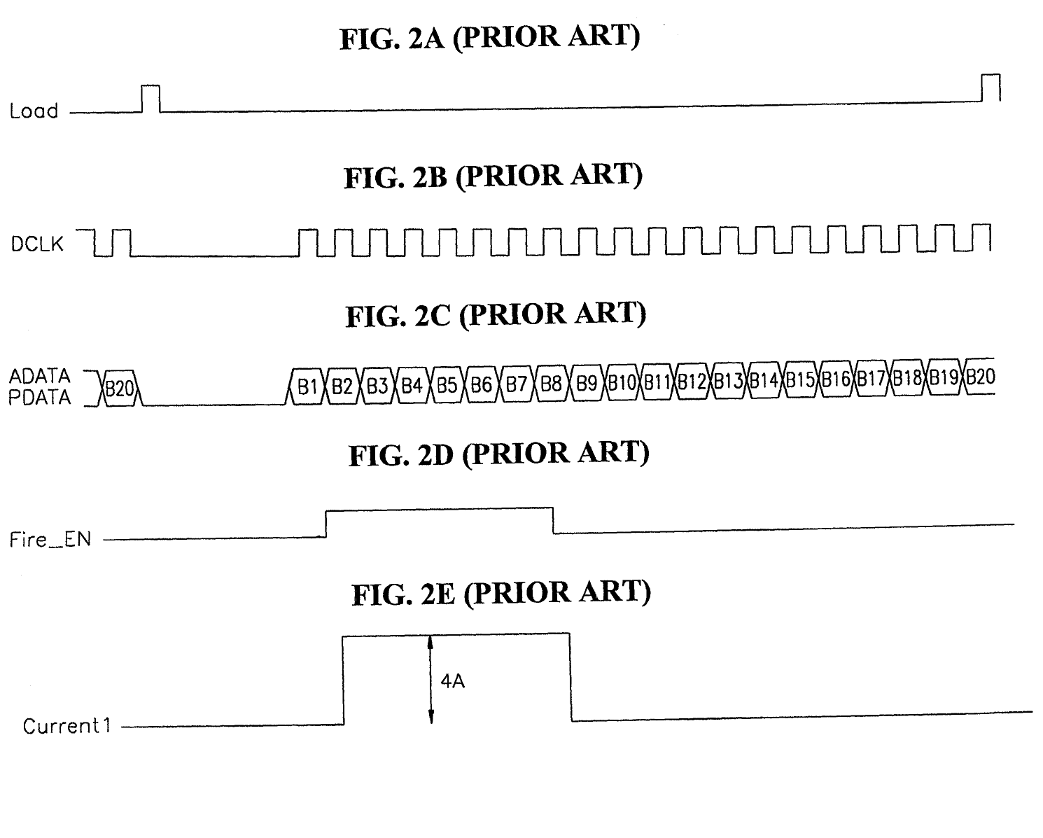

That is, the controller 210 generates the enable signals Fire_EN1 and Fire_EN2, which operate the nozzles 501 of ink jet print heads, and respectively drives the even numbered nozzles 520 and the odd numbered nozzles 510 with a predetermined time difference Td. Here, the nozzles 501 are divided into the odd numbered nozzles 510, as a first group of the nozzles 501 of the ink jet print heads 500, and the even numbered nozzles 520, as a second group of the nozzles 501 of the ink jet print heads 500, because the nozzles 501 are aligned in the print heads 500 in a predetermined order determined by a printer manufacturer. The maximum current consumed by an ink jet print head 500 of the printer 200 of FIG. 2 is half of the maximum current consumed by an ink jet print head of the conventional printer 100 of FIG. 1.

For instance, in the case that the current consumption per nozzle is 200 mA and that there are ten even numbered and ten odd numbered nozzles 510, 520, a maximum number of ten nozzles 501 can be driven in response to the nozzle group selection address ADATA, the nozzle selection address PDATA, and the first enable signal Fire_EN1 at a time. While the first enable signal Fire_EN1 is activated, a current of 2A flows momentarily through the ink jet print head 500. Also, in this case, the maximum power required by the ink jet print head 500 is 20 W, assuming that a driving voltage is 10 V.

Also, the maximum ten nozzles 501 can be driven by the nozzle group selection address ADATA, the nozzle selection address PDATA, and the second enable signal Fire_EN2 at a time. While the first enable signal Fire_EN2 is activated, a current of 2A flows momentarily through the ink jet print head 500. Also, in this case, the maximum power required by the ink jet print head 500 is 20 W, assuming that the driving voltage is 10 V.

Therefore, the maximum power required by the printer 200 according to the present invention can be reduced to the half of that of the conventional printer 100.

While the present invention has been particularly shown and described with reference to the preferred embodiment thereof, the present invention is not restricted to the above embodiment. Further, it will be understood by those skilled in the art that various changes in form and details may be made without departing from the spirit and scope of the invention as defined by the appended claims.

As previously mentioned, it is possible to reduce the maximum current consumed by the ink jet print head when a printer capable of reducing the maximum driving current of an ink cartridge of an ink jet printer and a method thereof are used, according to the present invention.

Also, the capacity of the power supply device can be reduced using such a printer and method, thereby lowering the manufacturing cost. Further, the maximum current consumption can be reduced, thereby reducing the distortion of signals.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus in an ink jet printer having nozzles, comprising:
a controller outputting addresses selecting respective ones of the nozzles, a first enable signal, and a second enable signal; and
an ink cartridge driving a first group of the nozzles in response to the addresses and the first enable signal, and driving a second group of the nozzles in response to the addresses and the second enable signal, wherein the first and second enable signals are generated from the controller by a predetermined time difference.

2. The apparatus of claim 1, wherein the first group and the second group of the nozzles are not driven at the same time.

3. The apparatus of claim 1, wherein the first group and the second group of the nozzles are aligned at different positions.

4. The apparatus of claim 1, wherein the ink cartridge drives respective nozzles of the first group of the nozzles in response to the addresses and the first enable signal and respective nozzles of the second group of the nozzles in response to the addresses and the second enable signal.

5. The apparatus of claim 1, wherein the first group of the nozzles and the second group of the nozzles are one of odd numbered nozzles and even numbered nozzles.

6. The apparatus of claim 1, wherein the ink cartridge comprises a first nozzle driving circuit driving the first group of the nozzles in response to the first enable signal and a second nozzle driving circuit driving the second group of the nozzles in response to the second enable signal.

7. The apparatus of claim 1, wherein the addresses comprises nozzle group selection addresses and nozzle selection addresses, and respective ones of the nozzles are selected by the corresponding nozzle group selection address and the nozzle selection address.

8. The apparatus of claim 7, wherein the selected respective ones are driven in response to one the first and second enable signals.

9. The apparatus of claim 7, wherein the selected respective ones of the first group of the nozzles are odd numbered nozzles, and the selected respective ones of the second group of the nozzles are even numbered nozzles.

10. The apparatus of claim 7, wherein the ink cartridge comprises a first nozzle driving circuit driving the selected respective ones of the first group of the nozzles in response to the first enable signal and a second nozzle driving circuit driving the selected respective ones of the second group of the nozzles in response to the second enable signal.

11. The apparatus of claim 1, wherein the predetermined time difference is variable.

12. The apparatus of claim 1, wherein the controller does not generate the first enable signal when generating the second enable signal.

13. The apparatus of claim 1, wherein the ink cartridge supplies a maximum amount of current to one of the first and second groups of the nozzles when all nozzles of the one of the first and second groups of the nozzles are selected and driven, and the ink cartridge does not supply the maximum amount of current to both the first and second groups of the nozzles at the same time.

14. The apparatus of claim 1, wherein the ink cartridge exclusively supplies one of the first and second groups of the nozzles with a maximum amount of current which is half a total amount of current consumed when all nozzles of the first and the second groups of the nozzles are selected and driven.

15. The apparatus of claim 1, wherein the controller controls the ink cartridge to exclusively supply a current to one of the first group of the nozzles and the second group of the nozzles in response to the first and second enable signals.

16. The apparatus of claim 1, wherein the maximum number of the nozzles, which are selected and driven at the same time, is half the total number of all nozzles of the first and second groups of the nozzles.

17. The apparatus of claim 1, wherein the maximum number of the first group of the nozzle is not more than half the total number of all nozzles of the first and second groups of the nozzles.

18. The apparatus of claim 1, wherein the cartridge exclusively drives one of the first group of the nozzles and the second group of the nozzles.

19. The apparatus of claim 1, wherein the cartridge alternatively drives the first group of the nozzles and the second group of the nozzles.

20. The apparatus of claim 1, wherein the controller controls the ink cartridge to consume half the total amount of power consumed when all of the first and second groups of the nozzles are selected and driven.

21. The apparatus of claim 1, wherein the first group of the nozzles is different from the second group of the nozzles.

22. A method of operating an ink jet cartridge having nozzles, comprising:
generating addresses selecting respective one of the nozzles, a first enable signal, and a second enable signal; and
driving a first group of the nozzles in response to the addresses and the first enable signal, and driving a second group of the nozzles in response to the addresses and the second enable signal, wherein the first and second enable signals are generated by a predetermined time difference.

23. The method of claim 22, wherein the first and the second enable signals are not activated at the same time.

24. The method of claim 22, wherein the first group and the second group of the nozzles are aligned along respective predetermined patterns.

25. A method of operating an ink jet cartridge, comprising:
outputting first and second enable signals to the ink jet cartridge; and
driving a first group of nozzles in response to the first enable signal, and driving a second group of the nozzles in response to the second enable signal, wherein the first and second enable signals are generated by a predetermined time difference.

26. The method of claim 25, wherein the first group and the second group of the nozzles are aligned along predetermined patterns.

27. The method of claim 25, wherein the driving of the first group and the second group comprises:
exclusively supplying a maximum amount of current to one of the first group of the nozzles and the second group of the nozzles in response to one of the first and second enable signals.

28. The method of claim 25, wherein the maximum amount of the current is half the total current consumed by all nozzles of the first and second groups of the nozzles.

29. The method of claim 25, wherein the first group of nozzles are different from the second group of the nozzles.
